(19) United States
(12) Patent Application Publication
(10) Pub. No.: US 2018/0060867 A1
(43) Pub. Date: Mar. 1, 2018

(54) Secure Electronic Payment Transaction Processing with Integrated Data Tokenization

(71) Applicant: Heartland Payment Systems, Inc., Princeton, NJ (US)

(72) Inventors: Mark Hagan, New Albany, IN (US); Jerry Roberts, Mount Washington, KY (US); Joseph Wysocki, Epsom, NH (US); Shane Logsdon, Louisville, KY (US)

(21) Appl. No.: 15/530,861

(22) Filed: Mar. 10, 2017

Related U.S. Application Data
(60) Provisional application No. 62/305,470, filed on Mar. 8, 2016.

(51) Int. Cl. G06Q 20/40; G06Q 20/10; G06Q 20/12; G06F 21/62; G06Q 20/34

(52) U.S. Cl. CPC G06Q 20/4014; G06Q 20/10; G06Q 2220/00; G06F 21/6245; G06Q 20/34; G06Q 20/12

(57) ABSTRACT

During the performance of an electronic payment transaction over a networked (web-based) e-commerce website an interface implementation that inserts into one or more web pages of the site providing an override within a payment process that allows a user to securely enter sensitive or confidential data necessary for the performance of the transaction and from which a transaction specific, single-use payment token is generated and then used in completing the payment transaction. The interface providing protection to the sensitive data and generated token from unwanted and unnecessary network access by a communicatively linked device and promoting a consumer experience that seamlessly integrates the date entry, protection and tokenization of sensitive data with the hosted webpages of the e-commerce website.

### BACKGROUND

Electronic transaction performance capabilities, for handling electronic payment transactions, have been enabled over systems composed of communicatively networked computing devices. Handling of the data within these systems has often employed various tools, techniques, mechanisms and capabilities in order to allow parties to accomplish secure transactions for various purposes.

Many current transaction management systems are established, at least in part, via a networking of a merchant's web-server that hosts a merchant's online shopping environment (e-commerce website) in communication with one or more other computing devices. In performing transactions it can be that the merchant's e-commerce site participates, at least to some extent, in the performance of an electronic payment transaction. It can be typical that many of these hosted e-commerce websites are unable to provide an online environment (platform) where reducing and/or minimizing the presence of cardholder data traversing or ‘touching’ the merchant website is enabled. If a primary account number (PAN) of a consumer's payment card (debit or credit) is retrievable by a merchant over their e-commerce site, the merchant's environment will be in scope for PCI DSS. A merchant's scope for PCI DSS can be a liability risk that may require a significant investment of resources to manage effectively.

Current transaction systems may employ various data security (processing or communication) techniques to protect a consumer's sensitive (private) data, such as payment information that can include a payment card number, card expiration date and card security code (CSC). Unfortunately, it may be typical that many of these data security techniques can contribute to increased transaction performance times. In addition, the application or execution of many data security techniques may impact on the consumer's transaction experience with the merchant's website. Such impacts may be experienced as disruptions in the consistency of the visual and/or interactive experience with the merchant's website where a customer is re-directed off the merchant's site.

Website breaches or hacks are an all too common vulnerability for many of todays e-commerce systems and their networked computing devices. Many of these websites are not able to provide the hosting authority or owner (e.g., merchant) with an early warning, the ability to terminate transaction performance or other security measure(s) when a breach is discovered during transaction processing. Thus, such breaches can result in the on-going unauthorized access to protected (personal/sensitive) data and information and expose the owner of the website(s) to significant liability risk for failure to prevent and/or immediately stop such occurrences.

Therefore, it would be desirable to provide a transaction management capability and/or system that promotes minimizing a merchant's PCI DSS scope and the presence of sensitive payment information traversing a merchant's e-commerce website. In addition, it would be desirable to promote a consumer's transaction experience by seamlessly integrating data security techniques with the merchant's website to reduce performance times and perceptible disruptions or interrupts. Still further, it is desirable to provide transaction management capabilities that promote data and information security where unauthorized access to a networked (e.g., e-commerce) website is a risk during transaction performance.

### BRIEF DESCRIPTION OF THE DRAWINGS

The objects and advantages of the invention will be understood by reading the following detailed description in conjunction with the drawings in which:

FIG. 1 is a block diagram illustrating a method for the performance of a card not present electronic payment transaction employing a JavaScript override;

FIG. 2 is a block diagram illustrating a method for the performance of a card not present electronic payment transaction employing an JavaScript and IFrame override;

FIG. 3 is a block diagram illustrating a method for tokenizing payment information during the performance of an electronic payment transaction;

FIG. 4 is a representative illustration of an electronic payment transaction system upon which an implementation of the override of the current invention may occur;

FIG. 5 is a block diagram illustrating a method for the performance of a card present electronic payment transaction using consumer payment data;

FIG. 6 is an illustration of a JavaScript override enabled system exemplifying a contemplated electronic payment transaction;

FIG. 7 is an illustration of a JavaScript and IFrame override enabled system exemplifying a contemplated electronic payment transaction; and

FIG. 8 is a block diagram illustrating a method for the performance of a card present electronic payment transaction using encrypted consumer payment data.

### DETAILED DESCRIPTION

Minimizing the presence of cardholder data or any payment data, such as PAN, in a particular merchant environment or network segment (e.g., e-commerce website) is an object of the current invention. An additional object of the current invention includes minimizing the merchant's ability to retrieve the PAN once a token has been generated. A still further object is to promote a reduction in PCI DSS scope for the merchant's e-commerce capabilities along with promoting the avoidance and/or mitigation of breaches, thereby reducing the risk of unauthorized access and/or any data loss to unauthorized parties.

In the various exemplary aspects and embodiments presented herein, the disclosure provides systems, methods, and non-transient machine-interpretable data representing executable instruction sets and/or other products for the processing of data. In particular, the processing of data relates to the secure capture, transmission, tokenization, administration, manipulation, processing, and storage of electronic data useful in the processing of payment transactions and other secure data processes.

For example, in various aspects and embodiments the disclosure provided herein describes the capture and tokenization of sensitive payment data, in a secure manner, during the performance of an electronic payment transaction. In various additional aspects and embodiments, the disclosure provides for the secure handling and processing of data, including data established in tokenized form. Functional capabilities and/or component features employed and provided by and for the current invention may be described herein as configured and presented in various manners. While some capabilities and/or features may be specifically shown and others not shown in the drawing figures presented herein, they are all contemplated for the current invention.

The present invention relates generally to systems, methods, and machine-interpretable programming and/or other instruction products that can be implemented over networked systems of computing devices for the secure handling and processing of data, which can include the tokenizing of data, in the performance of electronic payment transactions. Without limitation, the disclosure relates to the secure creation, administration, manipulation, processing, and storage of electronic data, wherein the data is in tokenized form, useful in processing of payment transactions and other data processes.

While the production and application of various embodiments of the present invention are discussed in detail below, it shall be understood that the present invention provides many applicable inventive concepts that may be embodied in a wide variety of specific configurations and contexts. The descriptive details herein provided for specific embodiments are not intended to limit the scope of the current invention, but merely illustrative of ways to make and use the invention. It should be emphasized that the terms “comprises” and “comprising”, when used in this specification, are taken to specify the presence of stated features, steps or components; but the use of these terms does not preclude the presence or addition of one or more other features, integers, steps, components or groups thereof. In addition, numerous and varied instances of the current invention may be described in different embodiments and for which specific descriptive aspects or elements may be referred. It is to be understood that the use of any such specific aspect or element is not, nor intended to be restricting or limiting, in any way, to only that particular aspect or element. Generally, such descriptions are intended to encompass the use of the various identified and described aspects or elements as are provided for the current invention throughout the instant specification.

In accordance with exemplary embodiments of the present invention, inventive objects are achieved in systems and methods and by implementation of computer program(s) that enable the data and transaction management capabilities for an electronic payment transaction as may be performed in various electronic transaction environments. Thus, while certain, specific capabilities are described within the context of electronic transaction management, the full scope of electronic transaction management capabilities can be understood to encompass and include, without limitation, providing any and all capabilities related to accomplishing a transaction.

In general, the transaction environments, online environments, online commercial environments, and/or e-commerce environments, provided by or within which the current invention can be established, establish an interface for a user, consumer, party and/or other identified person(s) to a transaction. The virtual or web-based transaction environments provided by or within which the current invention operates can be understood as one or more hosted websites, web-screens, webpages and/or any other virtual locations that are made accessible over an established network, such as the Internet, or otherwise. These transaction environments are accessible, such as via a network, by any communicatively coupled computing device, including web-based or Internet enabled computing devices. Therefore, user interaction with a transaction environment, whether established by or which includes the current invention as a component thereof, is enabled and allowed by these transaction environments.

As will be described, the network established by and for the current invention contemplates communicative coupling with various and potentially remote devices and/or systems, which can include any various computing devices, other networks of connected computing devices and any computing platforms capable of executing computer implementable instructions and/or instruction sets. As enabled by an implementation(s) of the current invention, it is within these transaction environments that user performance of designated or any and all functional capabilities is enabled.

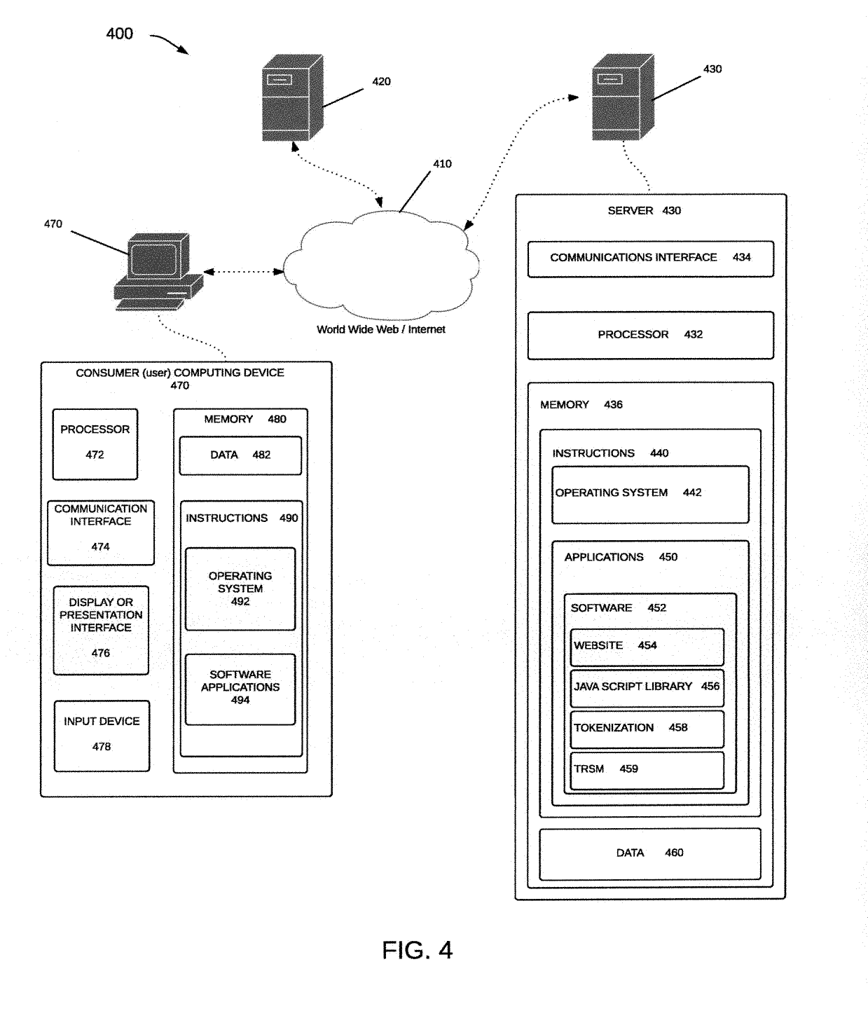

A configuration for the current invention is as a set of computer executable instructions embodied within a computer readable medium is commonly referred to herein as the “SS Software” or “SS interface”. The functional capabilities provided by the SS Software, when loaded in whole or part upon a server and/or user computing device, can be accessible through the use of various forms of communication systems capable of networking the various computing devices, thereby comprising an “SS System”, as illustrated in FIG. 4, including, but not limited to, the Internet, Intranet, Extranet, the Cloud, Local Area Network (LAN), a Wide Area Network (WAN), a Metropolitan Area Network (MAN), a Personal Area Network (PAN), or any combination of these or other suitable forms of communication networks known to those of skill in the art. Additionally, it is contemplated that any electronic transaction system, in which the SS software can be implemented and integrate the SS interface, can interface with other networks and systems and thereby interface with other currently existing software programs.

The current invention can enable a direct interface within networked systems, wherein a merchant's commercial online environment (e-commerce website) interfaces a customer's purchase with a secure data encryption, transmission and tokenization capability. The customer's purchase, which is at least a part of the customer's online shopping experience provided via a merchant's e-commerce website, can be conducted physically at the premises, via use of a merchant located web-enabled device (e.g., card reader device or point-of-sale), or online, via the customer's use of a customer web-enabled device. The current invention can be implemented as an independent instantiation of the SS software or as a part of an electronic transaction management software or system providing numerous capabilities.

The SS interface can be hosted by a merchant's e-commerce web server or other networked web server or a server farm in communication with the merchant's web server, wherein such other servers can be provided, owned and operated by any party. The SS interface can provide direct and secure communication with a data encryption and/or tokenization server, referred to herein as the “SS server”, in support of the performance of an electronic payment transaction. The SS interface promotes the seamless integration into the merchant's e-commerce website of the interface to the data encryption and/or tokenization capabilities without redirection from or loss of a user or customer from the merchant's e-commerce site.

A transaction management system of the current invention can be established wherein an implementation of the SS Software occurs within a merchant server (computing device), the SS server, another networked computing device or in a modular manner over multiple computing devices, that is or are communicatively coupled (networked) with additional computing devices. Such an SS system, over which the capabilities of the current invention are established and enabled can be established to provide a centralized electronic transaction management capability or a distributed transaction management capability, wherein the transaction management capability includes at least tokenization and secure data communication/transmission and handling capabilities.

For example, as a centralized service the transaction management capabilities can be loaded on a web server, in communication with other computing devices, from which the management of sensitive consumer payment data/information can be enabled. Alternatively, as a distributed service one or more of the transaction management capabilities can be provided as distinct component features (modules). These modules can be loaded in two or more networked locations, accessible by other networked computing devices, and capable of working independently and/or in operational concert to enable the management of all aspects of the current invention. In either architecture, user interaction with the functional capabilities provided by the SS software for transaction performance is enabled via the one or more transaction environments that can be established for a transaction. Therefore, any computing device(s) may allow user interaction with one or more transaction environments for a particular transaction via their communicative coupling (e.g., over the Internet) to an SS software implementation upon one or more networked computing devices.

The current invention can be part of enabling the performance of electronic payment transactions. In general, these types of transactions can be enabled within various electronic commerce environments, most preferably within e-commerce (online) transaction environments hosted by a merchant or retailer. The e-commerce environments can be hosted by any party, including merchants/retailers, that sell merchandise (products and/or services) to consumers via their e-commerce web site(s). A customer, user or consumer, using their web-enabled consumer device can be networked or communicatively linked to a merchant server hosting a merchant's e-commerce website. A web browser, executing upon the consumer's device, provides a display of the information being presented by the merchant's e-commerce website and enables the consumer, through various input means, to interact with the information being presented by and functional capabilities enabled over the website, such as allowing the consumer to “shop online”.

Therefore, it can be understood that the environment, context or general framework within which the SS interface can operate is an online shopping environment. During an online shopping session on typical e-commerce sites it is common that a customer selects one or more items of merchandise and these items are added to a “shopping cart” or other website provided functional capability until the consumer is ready to make a purchase through performance of an electronic payment transaction over the site. As part of the electronic payment transaction (checkout) process a “checkout” button is presented by the shopping cart, or other functionality, and upon selection/clicking of this button the website can initiate performance of the merchant's checkout process which may direct the customer to a checkout page or form. The checkout page, or at least a part of the checkout page, may request or require the customer to enter various information, which may or may not be considered sensitive information. For instance, the customer can or may not be required to enter their shipping address and select a preferred shipping method, and can or may not be requested to respond to a customer satisfaction survey or enter customer loyalty/reward program information. Upon capture of information that the merchant's checkout process determines necessary or required, the checkout process via the checkout form may present the customer with additional information requests regarding billing information.

The checkout form may present the customer with one or more data entry or input fields, a billing information screen or window to capture this type of billing information or other information. The merchant's capture of billing information can be enabled in various manners by the website. For example, a billing information screen may be displayed or perceived as an integrated part of the checkout form, a separate and distinct webpage from that of the checkout page or as a window or other subordinate display feature within the overall display framework of the checkout page. The billing information screen can display a customer perceived view containing one or more various data input fields for capturing various information items, such as the billing name, address and credit card and/or debit card fields (card number, expiration day, expiration year and CSC or CVV). Still further, such a billing information screen can present a “confirm” or “submit” button that enables the consumer or other user to post or transmit a transaction authorization request. Such transaction authorization requests being typically submitted or posted to a payment processing network through one or more servers, networked to the merchant server, that provide the gateway or entry point to a system for handling the transaction authorization and all other back-end transaction processing (i.e., clearance and settlement) for performance of an electronic payment transaction.

For various preferred embodiments of the current invention, a consumer using their consumer device can access a merchant's checkout page or form which is integrated with the SS interface thereby enabling the merchant website to present the consumer with an SS integrated checkout page or form, which can be referred to herein as an “SS integrated checkout page or form”, “SS checkout page or form” or “SSCF”. The SSCF, through any data entry or input field, can enable and allow for the capture of any data, for instance, sensitive consumer payment information, such as a consumer's payment account/card number, card expiration date (i.e., day and year) and a card security code (CSC). The consumer's payment account can be a credit card account or a debit card account. Other sensitive consumer information may include birthdate(s), social security numbers, or such other indicators that are themselves or identify other items of confidential information. While preferred embodiments of the current invention may not require or enable the capture of such other sensitive non-payment consumer information, it is contemplated that such capabilities can be included in the current invention or within systems over which the current invention is implemented. This SSCF can be rendered and perceived over the web browser display provided on the consumer device as a screen, webpage and/or parent window within which various data and capabilities of the website can be provided.

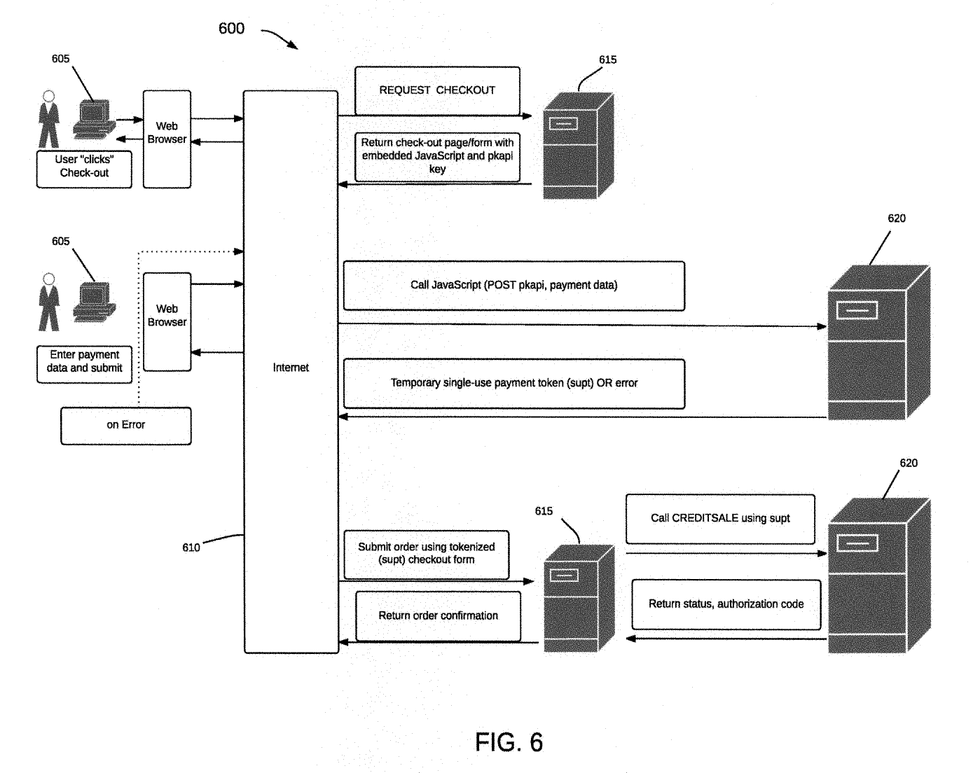

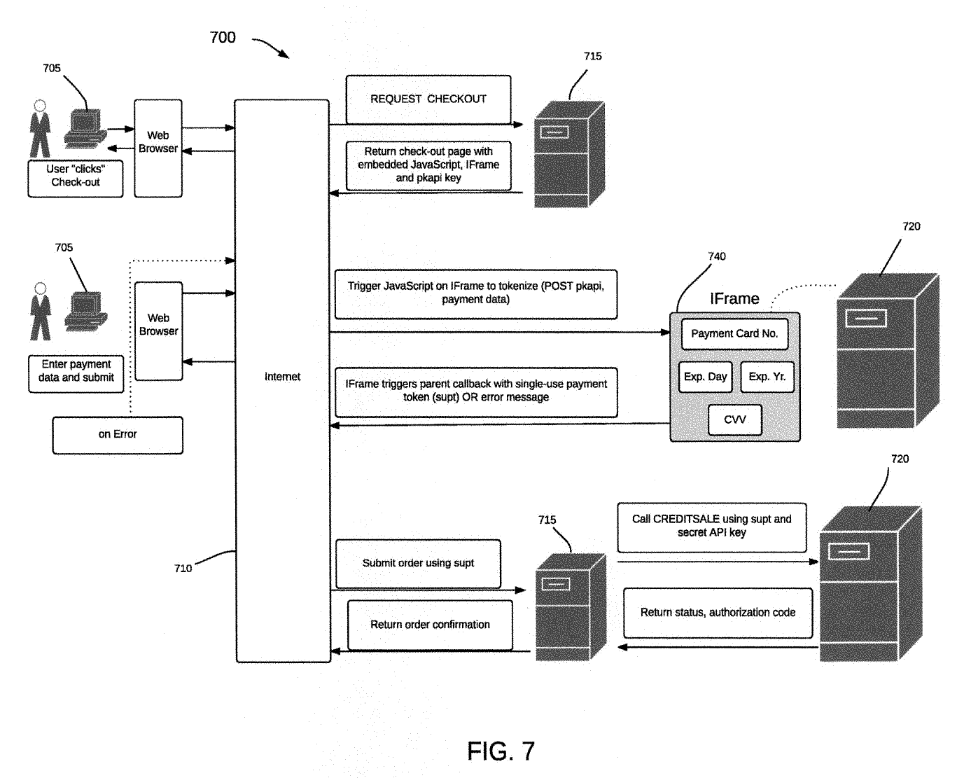

The merchant server hosts the SS integrated checkout page/form which can include an implementation of the SS interface as either (1) two JavaScript files; (2) two JavaScript files and one or more IFrames; or (3) one or more IFrames. The SS interface can also be referred to herein as an “override”, “override window”, “interrupt” or “secure submission window”. The JavaScript files and/or IFrame(s) can establish a communication link or interface to an SS server, which is a networked server that hosts a unique single JavaScript library and provides for the tokenization of data during performance of an electronic payment transaction over a networked e-commerce website. Thus, as shown in FIGS. 6 and 7, exemplary SS systems 600 and 700, respectively, via the SS interface a consumer is placed in direct communication with the SS server during performance of an electronic payment transaction via the consumer's device display of the SSCF hosted by the merchant server(s).

The SS interface overrides or interrupts the posting (submission or transmission) of a checkout request or transaction authorization request from the merchant server to a payment processing network. The override capability of the SS interface can be implemented as JavaScript code(s)/file(s) that are integrated with or embedded inside another HTML document, such as the merchant's checkout form. It is understood that the integrated/embedded JavaScript file(s) on a merchant checkout form can establish or integrate a JavaScript library from any networked location within the electronic transaction processing capabilities being enabled over an e-commerce website. The addition of the JavaScript to the SSCF or other merchant's server hosted web-page(s) can occur in one of two ways. For instance, Script tags can be placed in a webpage and the JavaScript code can be placed inside of those or all JavaScript code can be placed in another file and linked to by a Script tag. In preferred embodiments, the SS interface is implemented as a Script tag(s) containing or linking to two JavaScript files. However, the number of files (i.e., JavaScript or otherwise) employed may be any number that is necessary for proper implementation of the SS interface in various different online e-commerce transaction system environments and over any networked computing device. It is contemplated that integrating a JavaScript library can be enabled using various technologies, such as jQuery, Angular, Prototype or other code(s)/file(s) as are commonly employed by those skilled in the field.

In embodiments, the JavaScript implementation of an SS interface may be integrated with the merchant checkout form and upon selection of a submit or confirm button found on such an SSCF, the JavaScript override may temporarily prevent the posting of the SSCF to a payment processing network for transaction authorization. It is contemplated that where the SS interface of the current invention is not embedded in a merchant's checkout form the selection of the submit/confirm button can result in the posting of the SSCF as a transaction authorization request submission to the payment processing network.

For the SSCF, selection of the submit or confirm button can also trigger or initiate the transmission of a tokenization request to the SS server before the transaction authorization request is allowed to be posted. The tokenization transmittal is a secure transmission protected using one or more data security/encryption protocols. A tokenization request transmittal can include various data elements, either as individual or accumulated elements, captured from one or more of the data entry or input fields enabled and presented by the SSCF, a merchant's checkout form, a window on the website and/or a billing information screen. The data elements can include items such as a personal account number (PAN), other consumer payment information or other sensitive data. The tokenization request transmittal can also include data and information captured from a reading of a magnetic stripe (magstrip) on a payment card, such as track 1, track 2 or other captured data. It is further contemplated that the tokenization request transmittal, through employment of various data encryption technologies integrated or in cooperation with the current invention, can therefore include encrypted data, such as PAN, other consumer payment information, Type 1, Type 2, track 1, track 2 or such other encrypted information as may be necessary in the performance of a transaction enabled by an SS system.

The duration of the delay in the posting of the checkout/transaction authorization request, which may be referred to herein as the “tokenization delay”, can be understood as the time required for the merchant server to receive a single-use payment token from the SS server. It is contemplated that the tokenization process executed by the SS server promotes no or almost no perceptible delay in the posting of the checkout request and therefore transaction performance. It is contemplated that the tokenization delay can be a pre-determined value established by the SS software and may promote the use of various other capabilities being enabled by and over an SS system of the current invention.

The SS server tokenizes the data received, generating a transaction specific, single use payment token (SUPT) and then securely transmits the SUPT to the merchant server via the SS interface. The merchant server inserts the SUPT within the merchant's checkout form, which along with any other necessary transaction information, enables the generation of a complete checkout form. SUPT insertion is a replacement of the input fields in the SSCF used to capture the data elements that were transmitted to and tokenized by the SS server. The merchant server can then submit, transmit or post the complete checkout form to the payment processing network for back-end processing, which can include transaction clearance and settlement.

It is understood that the SS server can be a gateway server for a payment processing network. In such embodiments the SS server, along with its tokenization capabilities, can provide various transaction functionalities, including authorization functionality, for the payment processing network. In such a system embodiment, the SS server's transaction authorization functionality is initiated by the merchant server's posting of the complete checkout form. It is contemplated that a transaction authorization request can be submitted by the merchant server simultaneously with the transmission of a tokenization request. It is further contemplated that a transaction authorization request can be submitted via the merchant server or override.

Regardless of the origination of the transaction authorization request and/or the coordination established with the tokenization request submission, performance of the electronic payment transaction over the SS system is enabled to occur in real-time. The processing functions being performed by more than one server or computing device are enabled to support and promote the efficient overall transaction performance and reduction or avoidance of any processing latencies or delays. This, along with other improved consumer oriented features provided by the SS interfacing within a merchant checkout process can provide a significantly improved payment transaction processing environment enabled to be established, at least in part, by the current invention.

As indicated above, the JavaScript implementation of the SS interface can be integrated or embedded utilizing a Script tag that includes the JavaScript code/file(s) and/or a link to the JavaScript code/file(s) provided by a Script tag with any data entry and/or input field configuration established or utilized by the current invention. It is common for the JavaScript code to be rendered by a web browser application executing on a particular device, such as a consumer's web-enabled device. Such a rendering is understood as a client-side script and can be employed for any embodiment of the current invention. Alternatively, JavaScript can be implemented and run on a web server, which can include without limitation a merchant's server and/or SS server. Thus, it is contemplated that a merchant server, SS server or other web server can generate HTML documents, thus running as a server-side script, which can also be employed for any embodiment of the current invention.

The SS interface can be established to include or as an “iFrame”, “IFrame” or “Inline Frame”. An IFrame is understood as JavaScript code(s) or an HTML document that is integrated with or embedded inside another HTML document. The IFrame(s) configured SS interface can be one or more code insertions and/or HTML documents that can be integrated within another HTML document. Therefore, one exemplary configuration provides an SS interface configured with both a JavaScript override (as described above) and an IFrame, which is an HTML element that inserts content (also referred to herein as a window(s)), hosted in part or in total, by the merchant server or SS server, into the merchant's checkout form. Another exemplary configuration provides an SS interface wherein the JavaScript override and any other inserted content is established in and as part of the IFrame being hosted, in part or in total, by the merchant server and/or SS server.

The SS interface, in any configuration, can be rendered by the web browser application executing on the consumer's device that enables the display of the merchant's e-commerce web page(s), such as the SSCF. As displayed for instance by a web browser on a consumer device, an IFrame(s) can be perceived as an integrated child or subordinate window or any number of such windows within a merchant's checkout form or SSCF (the parent or primary window) as it is presented by the merchant's website. It is also contemplated that an IFrame can be run at the merchant or SS server before the checkout page is sent to the consumer's web browser.

The SS interface can be enabled to allow for and provide direct and/or indirect communication of information to the SS server or other networked server(s). For instance, information or data captured in the data entry or input fields of an SSCF can be transmitted to a secondary networked device, such as a server or other computing device, prior to its communication from that secondary device to the SS server. It is further contemplated that the SS interface can provide connection to any other networked server or other web-based, communicatively linked computing device. These additional communicative linkages can allow the current invention to also present, make accessible or integrate any additional functionalities as may be contemplated. For instance, additional functionalities may include those provided by networked Loyalty/Reward programs, e-coupons, other promotional programs or any other functionalities as may be contemplated for use.

Various types of data entry and/or input fields can be enabled and implemented within a merchant's checkout form. The fields can be perceived as a pop-up window(s), dropdown menu(s), status message bar(s) and such other configurations as may be implemented by those skilled in the art. The one or more data entry or input fields, windows or other designated input locations in the SSCF, whether or not such fields are configured as part of an IFrame SS interface implementation, can be displayed on the consumer device and allow for the entry and capture of various data and/or consumer information. The consumer information captured can be any type of data or information, sensitive or not, payment information, cardholder information and/or data or information whose capture and processing during the performance of an electronic payment transaction is or is not subject to policies, regulations and/or laws from one or more authorities. For instance, information captured can include shipping address, credit or debit card number, card expiration data, card CSC, and various other types of information.

It can be understood that the capture, transmission and tokenization of consumer payment information for electronic payment transaction performance are capabilities provided by the merchant server, or other networked server, such as the SS server, and can be within the merchant's checkout process. However, the consumer's experience with the merchant's website checkout process appears seamless, further promoting brand identity, because the consumer does not experience a re-direct off the merchant hosted checkout process while completing the checkout form and/or billing screen for their payment transaction.

As shown in FIG. 7, and for exemplary embodiments of the current invention, the SS interface 740, hosted by the SS server, can be configured to include 4 IFrames that represent four (4) data entry or input fields. The four data entry fields are established for capturing consumer payment information or data, including the consumer's payment (credit or debit) card number, the payment card expiration day, payment card expiration year and the payment card security code (csc or CSC).

It is contemplated that one or more data entry or input field(s) established by the override of the current invention may provide a functional capability. For instance, an IFrame may comprise a “submit” button that is embedded with the JavaScript code/file such that selection of the submit button initiates the transaction interrupt and initiates the tokenization process hosted by the SS server. It is contemplated that the override of the current invention may comprise any number and/or types of data capture functionalities and/or action requests. These various functionalities and request capabilities may be identified in varying manners, such as the use of different indicators and/or forms of information display, selection and capture.

There are different terms for a payment card security feature for the performance of electronic payment transactions where the payment card is not physically present at a merchant's location or information from the payment card is not captured through reading of the magstrip on the card, such transactions often times referred to as “card not present” payment card transactions. The current invention can be used in the performance of such ‘card not present’ electronic payment transactions. It is understood that the CSC security feature mentioned above may also be referred to or called card verification value (CVV), card verification code (CVC), signature panel code (SPC), card verification data, card verification number, card verification value code, verification code (V-code or V code) or card code verification. As will be described herein, the current invention can also be used in the performance of “card present” payment card transactions, wherein the information from the payment card is captured through a reading of the magstrip on the card by a card reading device in communication with a computing device employed in an SS system.

FIG. 4 is an exemplary SS system 400 of the current invention, comprising a merchant (first) server 420, SS (second) server 430, and consumer computing device 470 that are communicatively linked or networked via the Internet 410. Various and different types and numbers of computing devices can be networked within an SS system of the current invention. While different computing devices may be described with greater, fewer, different component features and/or capabilities it should be understood that each device may include similar features and capabilities. For instance, networked computing devices that can be employed as a merchant server, SS server and/or gateway for a payment processing network for use with the current invention can include any server computer or multiple computers in a server farm or other computing array architecture. Server 430, which can be understood as an example of a server that can be employed as a merchant server, SS server and/or gateway server for the current invention, can be communicatively coupled to one or more server computers, such as server 420 and user computers, such as the consumer computing device 470, via the network 410. The server 430 may be a server or other computer system that communicatively couples several component features, such as a processor 432, a communication interface 434 and a memory 436. A communications bus (not shown) can be employed to enable communication between the processor 432 and the other component features of server 430 and any additional component features that can be added and as may be contemplated by those skilled in the held. Processor 432 is enabled to execute instructions 440 and/or save and/or retrieve data 460. System memory 436 can store instruction set 440 that can be understood to include the computer operating system(s) 442 and/or the applications suite 450 which can define all or at least some of the operational capabilities for the server 430.

The consumer computing device, consumer device and/or consumer web-enabled device that may be employed for use with the current invention can include, but are not limited to, any of the following: personal computers (PC's), desk-top computers, mobile computers, any type of mobile computing device, computing workstations, laptops, tablets, portable computers, hand-held devices, personal digital assistants (PDA), smart phones or any other Internet- or web-enabled phones and devices, wireless devices, web-based technology systems, touch screen devices, typing devices, and any other similar electronic device enabled as shown.

A consumer (user) computing device 470 is a general purpose computer including any of the standard component features well known to those skilled in the art. User computer 470 can include a processor 472 communicably linked via an internal communications bus (not shown) with a memory 480 to store data 482 and instructions 490, such as operating system 492 and/or other applications 494. The processor is able to execute instructions, such as instructions 490, and/or to access and/or manipulate data 482. In certain embodiments, general purpose computer 470 may be adapted to execute any of the well known, commercially available operating systems including, without limitation, MS-DOS, PC-DOS, OS2, UNIX, MAC-OS and Windows operating systems, or any other available operating systems. As used in this document, operating system may refer to the local operating system for computer 470, a network operating system, or a combination of both. Where a user computer is a mobile computing device the implementation of operating systems specific for mobile computers can be employed.

The consumer computing device 470 may include a display or presentation interface 476 that provides a display that presents information to a user, for example, webpages, an SSCF and/or any other interfaces hosted over an SS System can be presented and user interaction enabled. The user computer 470 also includes a communication interface 474 that facilitates communication via network 410 with the servers 420 and 430 and any other networked computing devices. The communication interface 474 can also facilitate communication with other computing devices, networks, and/or systems not networked within the SS System.

Any networked computing device employed by the current invention enabled by standard computer features and hardware may be capable of operating a web browser (i.e., Microsoft Internet Explorer, Netscape Navigator, Mozilla Firefox, Safari, Google Chrome, etc.). Further, any networked computing device can be equipped with and/or enabled to interact with various electronic document processing capabilities, such as that provided by Adobe Acrobat (pdf), Microsoft Word, and/or any other commercially available or proprietary computer programs which enable the performance of any aspect of the current invention. As used in this document, operating system may refer to the local operating system for a computer, a network operating system, or a combination of both. Where a user computer is a mobile computing device the implementation of operating systems specific for mobile computers can be employed.

Entry of information into a computer, whether enabled as a mobile or non-mobile computing device, personal computer or server computer, can occur through the use of an input device. Input device can be various input devices including, but not limited to, mouse/pointing devices, keyboards, electronic and light pens, signature pads, touch screens, scanners, light pens, stylus, biometric devices and any other similar electronic input devices known to those of skill in the art. These input devices can facilitate all input, such as obtaining data and other acts performed for an electronic payment transaction, from a user. Thus, it is contemplated the user computer can be established with and allowed to work together with software that enables all manners of interaction with electronic documents, such as checkout pages, presented and/or displayed by the user computing device. The above description provides merely one, non-limiting, example of a computer that may be used with the invention.

The consumer device can run or operate under an operating system that provides a graphical user interface “(“GUI”) for accessing software applications, such as a web browser. A GUI may be used in any of the embodiments for the current invention. Through an interface of windows, menus (pull-down or otherwise), and/or toolbars, GUI operating systems simplify device operation. The use of windows is conventional in GUIs for software applications and are typically utilized to provide end users (consumers) of applications with display of and/or access to available information, choices or processing options while using the application(s). For example, in a typical interactive web browser application, a window can provide the context within which a display of the contents of a web page from a hosted website occurs on the end users device. While a single window may comprise a display, it is commonplace today that a window can be a “parent” window within which additional subordinate or “child” windows can be associated and/or displayed.

In preferred embodiments of the current invention, the display provided on the consumer device of the SSCF, may appear as a parent window within which four (4) child windows (e.g., data entry/input fields) appear. The parent window is a display of the merchant's checkout form within which the four input fields or child windows can be the IFrames being implemented therein. As described previously, the four input fields or child windows can comprise the payment card number, payment card expiration day, payment card expiration year and payment card CSC. It is contemplated that greater or fewer input fields/child windows can be established by the SS interface and that various different types of input can be requested and captured.

The input fields or child window options, regardless of the number of perceivable fields or child windows, are displayed for perception within context of the parent page or window and can allow user interaction therein. User interaction enabled can include anything from a user's input of data, to a user's selection of various functional or performance options that can be presented to a user. It is contemplated that the input fields or child windows can be established with various restrictions and/or limits on the user's interactive capabilities as may be best suited for any particular web-based environment. It is contemplated that the input fields or child windows be displayed in varying manners of proximal relation to one another within the parent window. Still further, one or more input fields or child windows may have additional subordinate fields or windows presented/displayed. Thus, it is contemplated that the current invention may utilize a hierarchical and/or cascading set or sets of field or window options displayable to show the parent/child relationships providing the desired functionality in the context of the action being taken within the performance of an electronic payment transaction.

Still further, the GUI may be enabled to display certain information to a user in a different manner, such as through the use of menus. The display of menus of information are currently commonly used and known. Menus can allow user interaction, including selection of options, with the information being presented therein. Thus, it is contemplated that the current invention may utilize a hierarchical and/or cascading set or sets of menu options displayable in context to show the parent/child relationships providing the desired functionality in the context of the action being taken within the performance of an electronic payment transaction.

Consumer payment information can be entered into input fields or IFrames via the input capabilities of the consumer device and communicated via the web browser executing upon the consumer device to the webpage (e.g., SSCF) hosted on the merchant's website. The SS interface enables communication of the captured consumer payment information strictly and directly between the consumer's web-browser and the SS server. Therefore, it is contemplated that at no time does consumer payment information or any other sensitive payment information ever touch the merchant's server(s). Still further, the SS interface promotes and/or ensure that the merchant server(s) does not have access to payment information, does not store the payment information (not even temporarily via a buffer or cache), nor does the payment information data traverse the merchant server(s).

It is contemplated that the SS interface of the current invention can communicate various data or information to various different networked devices and locations. For instance, the override can establish and integrate one or more input fields or windows or sets of such into a website, wherein one or more of the input fields or windows can enable the capture and transmission of non-payment or non-sensitive data and/or information for which restriction(s) on access and processing can be different than that established for other component features of the override that allow for the capture and transmission of consumer payment information or other sensitive information.

Upon or after entry of the consumer payment information the “submit” button can be clicked and the transaction interrupt or override can be initiated, whereby a tokenization request is sent to the SS server. It is further contemplated that selection of the submit button can trigger the transmission of a transaction checkout (authorization) request to the SS server. In such a manner, a transaction authorization request is also a tokenization request and, thus, can initiate the tokenization process(es). Alternatively, the tokenization request can be separate from and/or transmitted separately from the transaction authorization request and/or require some manner of manual interaction to begin. In preferred embodiments, the tokenization process(es) are hosted and executed by the SS server, but can be hosted and executed from any networked computing device and location.

The submit button can enable the transmission of the tokenization request to any designated networked location for processing, such as a networked server other than the SS server. The current invention can require the manual selection of the submit button by a user, where selection occurs by clicking the submit button by the consumer, prior to the override initiating the transmission of a tokenization request. Alternatively, the submit button may be implemented in any manner that enables an automatic transmission of the tokenization request upon occurrence of a predefined action, such as completed data capture based on data entry into specified input fields. It is further contemplated that the manual or automated transmission of a tokenization request by the SS interface also enable a similar transmission for a transaction authorization request.

Consumer payment information and any other data that is entered within the networked system by and from any networked device can itself be encrypted and/or the transmission of the information have encryption or other security protocols applied. In a preferred embodiment, an HTTPS/TLSv1.2 is utilized for the encryption and secure transmission of the consumer payment data from the SS interface to the SS server and the SUPT from the SS server to the SS interface.

It is contemplated that various data and communication protocols can include at least one of an authentication protocol and security protocol. An authentication protocol(s) can include at least one of point-to-point or architecture protocols. A security protocol(s) can include at least one of symmetric (secret) key encryption and public key encryption. Symmetric key encryption can include at least one of stream ciphers and block ciphers (of various bit size). Public key encryption protocols can include at least one of Transport Layer Security, S/MIME, PGP and MGP. It is further contemplated that other additional data security functionalities, such as those related to data encryption at the point of initial data entry and capture may be provided and employed in performance of the current invention.

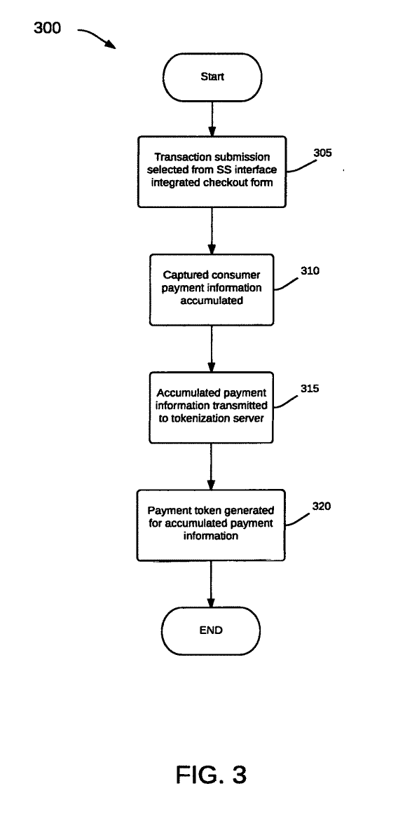

The following generally describes various functions enabled by the SS interface in providing the transaction interrupt and the tokenization process as can be performed by the SS server for the current invention. Use of specific descriptors to identify aspects of the current invention, such as “windows”, should be understood as illustrative and in no way limiting of the scope of the current invention. The SS server performance of a tokenization process 300 can occur in various manners, as illustrated in FIG. 3, the process can begin at 305 with the selection of a submit functionality for the transaction. Upon selection of submit the consumer payment information is accumulated at 310. Once accumulated, this information is then transmitted to the SS (tokenization) server at 315. With the accumulated payment information, the SS server, at 320, executes a tokenization process resulting in the generation of a transaction specific, single-use payment token (SUPT). This SUPT can then be used for further transaction processing as described herein. In another embodiment, the tokenization process is initiated by receipt of a tokenization request from the SS interface and results in a message being sent from the submit button window to the payment card number window. The message contains at least one request for consumer payment information and may also include various instructions and/or additional requests for other actions. Once the card number window receives this message from the submit button window, the card number window sends at least one or more messages to each of the other windows (card expiration day window, card expiration year window and CSC window) requesting the data captured and/or being held within their respective input fields. Upon receipt of the request message received from the card number window, these windows send their respective data to the card number window. Once all data from the CSC window, card expiration day window and card expiration year window is received by the card number window the card number window accumulates the card data into and/or as a part of the tokenization request.

Once the necessary data has been captured, accumulated and formatted for the tokenization request, the card number window can send the data to the SS server. The accumulated data set can have any known encryption protocols applied and the transmission of the data to the SS server can be accomplished using any known encryption and/or security protocols as has been indicated.

The tokenization of the accumulated data received from the card number child window is effected by the SS server. Upon receipt of the accumulated data, the SS server can decrypt any encryption or unlock any protection that may have been applied to the data or its transmission and perform the tokenizing of the data utilizing one or more of numerous tokenization techniques, methodologies and processes that are well known and understood. The outcome of the execution of any tokenization process applied to the data received by the SS server is the generation of the transaction specific, unique, SUPT. Thus, the current invention provides a single use tokenization system capable of generating a unique, SUPT that represents a specific, single electronic payment transaction.

Tokens can be generally identified as either single-use or multi-use. It is contemplated that the current invention may employ a tokenization system capable of generating a multi-use token to represent a particular data value(s), wherein the data value(s) can comprise various data items, such as the accumulated consumer payment information heretofore described or a single data item, such as a specific primary account number (PAN). These tokens may be used to track any data value(s) across multiple transactions. A multi-use token always maps a particular data value to the same token value within the tokenization system. Whether single-use or multi-use tokens, or a combination of both, are employed by the current invention, promoting the protection of sensitive consumer payment data is provided by the current invention.

Common forms of token generation which can be employed by and for the current invention to provide a robust tokenization system capable of generating single- or multi-use tokens include but are not limited to: (1) a mathematically reversible cryptographic function, based on a known strong cryptographic algorithm and strong cryptographic key (with a secure mode of operation and padding mechanism); (2) a one-way non-reversible cryptographic function (e.g., a hash function with strong, secret salt); and (3) assignment through an index function, sequence number or a randomly generated number (not mathematically derived from a particular data value(s), such as a PAN).

As will be appreciated by those skilled in the relevant arts, once they have been made familiar with this disclosure, a secure payment token for use in performance of an electronic payment transaction can comprise an encrypted or otherwise secure data set representing all information required, when deciphered and/or otherwise properly interpreted, to effect and/or evidence payment, or authority for payment, of fixed or unfixed, limited or unlimited, and/or otherwise pre-authorized amount(s).

Such token(s) may, for example, be generated and stored, at least temporarily, in a central computing device(s), such as the SS server, which can be physically located in or at one or more geographic locations. The central computing device(s)/locations can be made accessible to other computing devices by any and various communication capabilities and utilizing any and various communication security/encryption protocols as have been described herein.

Storage of such token(s) can be temporary or permanent. For example, the token(s) generated by the current invention may be stored only within a computing device temporary storage location, such as a buffer or cache. Such storage may only provide storage, access to and use of the token(s) during performance of an electronic payment transaction. Upon completion of the electronic payment transaction or at some pre-determined stage of the transaction prior to its completion the token(s) may be removed (e.g., erased or deleted) from any temporary storage location, wherein such erasure/deletion can result in the token(s) no longer being stored in or available to any computing devices. The token(s) removal can occur via an automated or manual initiation of a removal process and may provide for the partial or total removal of the token(s) from any storage location(s).

The SS server which received the consumer payment information as part of the tokenization request can remove all consumer payment information received from any storage and/or processing location within the SS server. While it is contemplated that information and data may be found in the SS server, in one or more temporary or permanent storage locations, the tokenization process(es) and any other data handling enabled by the SS server can promote compliance with all rules, laws and regulations or policies governing the use of sensitive, private or other protected information.

Prior to any manual or automated transmission requesting data tokenization request, which may or may not include a transaction authorization request, a verification process may execute that requires all input (consumer payment data) fields or windows be completed in accordance with predetermined requirements. Verifiable completion of any one field or window may require satisfaction of data entry requirements specific to it. For instance, and without limitation, the card number child window may require that sixteen (16) numeric digits be entered, the card expiration child window may require that eight (8) numeric digits be entered and the CSC child window may require three (3) numeric digits. Verification may fail where the data entry within a particular input field does not meet the predetermined requirements. Verification failure may result in various outcomes which can include anything from various prompting of the consumer to complete the unverified data field to transaction denial.

In addition, and prior to any transmission of a data tokenization request, which may include a transaction authorization request, a validation process(es) may execute that provides one or more forms of confirmation for the data entered. This confirmation may be anything from a user prompt asking for an action to indicate that the data entered is accurate, to an automated check or comparison of the entered data against a stored data set, to further providing an interactive functionality that allows for correction of any incorrect entered data.

The SUPT generated by the SS server is securely transmitted back to the SS interface and, therefore, the merchant server. This transmission can also be encrypted and protected using protocols, as has been previously described herein. The transmission of the SUPT allows the merchant server to utilize the SUPT in completing the checkout form and the electronic payment transaction process as described herein.

It is contemplated that the SUPT, once generated, may be transmitted to various networked locations and various networked devices. In such an alternative embodiment, the SUPT may be transmitted to and stored in a consumer device, such as a mobile telephone (e.g., a “smart” phone) or other personal digital assistant (PDA), and may be presented electronically at a point of sale (POS) or point of transaction (POT) as legal tender of a specific, previously-authorized payment useful in completing, or helping to complete, an identified transaction, or as evidence of credit or other binding payment authorization. Such payment can, for example, be analogous to presentation of cash at the point of sale, or to presentation of a credit, chip or other value-transfer card in a ‘card present’ transaction.

Upon receipt of the SUPT by the merchant server, the merchant server can continue the performance of the checkout process for the transaction. This includes processing the SSCF into a complete, completed or tokenized checkout form for submission to a payment processing network for further payment transaction processing. Therefore, upon SUPT receipt the merchant server performs a replacement within the SSCF (merchant's checkout form). The replacement is an insertion of the SUPT into the data entry/input fields that were presented by the merchant's checkout form and that comprised the accumulated sensitive (consumer payment information) data set transmitted as part of the tokenization request. It is contemplated that the SUPT can be inserted into an SUPT data field established in the SSCF. It is understood that the SSCF can also include various additional data or information, such as generic data (shipping name, shipping address, purchase item(s) selection, expiration date, last four of a card number, etc. . . . ). This generic data may or may not be included to establish a complete checkout form.

After the SUPT replacement described herein, and along with any other information captured by the SSCF and necessary for transaction processing, the complete checkout form can be displayed to the consumer via the consumer device. It is contemplated for embodiments of the current invention that the transmission and replacement performed for the SUPT may not require the SUPT to traverse or be stored, either temporarily or permanently, in a memory located within the networked consumer device or any other networked device.

The merchant server can post (transmit) the complete checkout form, including the SUPT and any other necessary transaction information, to a gateway server for a payment processing network. It is contemplated that the posting of the completed checkout form comprises in total or at least a part of the request for further payment transaction processing (transaction authorization) being sent from the merchant server to the payment processing network gateway. As described herein, it is contemplated that the gateway server for the payment processing network can be the SS server, so the completed checkout form, including at least the SUPT, can be sent from the merchant server to the SS server for further payment transaction processing.

The SS server (gateway for payment processing network), upon receipt of the complete checkout form, makes the initial determination of whether or not the transaction is or is not authorized to proceed. Where the transaction authorization request is a denial or approval, the SS server can send a message to the consumer, via the merchant server hosted checkout page being viewed by the consumer on the consumer device, informing of such. It is contemplated that the display of this information to the consumer may occur via an alternative web-page of the merchant's e-commerce site. With this information the merchant server can perform any back-end process(es) for denying and/or approving the requested transaction. For instance, the merchant server can use the tokenized checkout form to complete a credit card sale transaction or a debit card sale transaction.

It is contemplated that a re-direct may be employed, taking the consumer off of the checkout webpage or merchant's e-commerce site, in promoting the processing of transaction denials or approvals. The re-direct may take the consumer to a webpage hosted by the SS server or a third party SS system networked server or another webpage hosted by the merchant server. This re-direct can provide the consumer with access to various different functional capabilities and enable consumer interaction with such.

The SS software can enable various processing and/or functionalities with respect to the SUPT upon transaction approval or denial. For instance, where a transaction is denied the SUPT for a specific transaction may be removed and/or deleted from the completed checkout form. This removal from the completed checkout form can delete the SUPT from any location on the merchant server or other SS system networked server and allow no further use or processing of the SUPT to be performed. Additionally, the SUPT for a denied transaction may be (1) removed and/or deleted from a storage and/or processing location of the merchant server and/or other SS system networked server or (2) retained/stored, temporarily or permanently, in a storage and/or processing location of the merchant and/or SS system networked server.

Upon transaction approval the SS system may temporarily or permanently maintain the SUPT for purposes of completing the transaction. It is also contemplated that where the SUPT remains available, either temporarily or permanently, for the performance of additional processing by a merchant server and/or SS system networked server that this may promote the performance of additional payment transaction processing functions. Thus, once the data is tokenized, the merchant server or other networked server in the SS system can be enabled to reference the transaction and card using the unique SUPT to perform various actions, such as returns, card verifications, refunds, reversals, voiding transaction, editing transactions, transaction reporting and such other actions as may be contemplated by those skilled in the field. However, upon completion of the transaction and any additional processing of actions using the SUPT, the SUPT may be deleted, erased or cleared from the SS system.

### Example: 1

### JavaScript Only

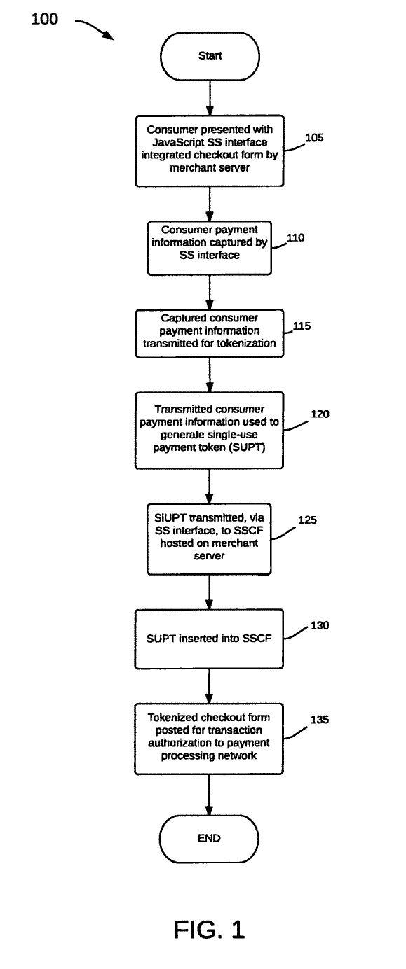

By way of example, and as illustrated in the method 100 of FIG. 1 capable of being implemented over an exemplary SS system such as system 600 of FIG. 6, the following provides an exemplary SS software implementation thereby establishing an SS system over which the various electronic payment transaction capabilities provided by the SS software can be enabled. In this example, the SS software is providing a JavaScript only implementation of the SS interface, wherein the SS interface is integrated in a checkout page provided by a merchant's website and enables the secure communication and tokenization capabilities provided by the current invention for a card not present transaction.

A customer, user or consumer, using their web-enabled, mobile phone 605 accesses a merchant's e-commerce website. While the exemplary illustration of FIG. 6 provides a device 605 in a generic computing device configuration, it is understood and described herein that the consumer device can be any web-enabled device, such as a mobile phone or smartphone. Therefore, FIG. 6 should not be understood as restrictive of the exemplary consumer computing device employed for the current invention. This access is established over the Internet 610, providing a communicative link between the consumer's device and a server (merchant server) computing device 615 that hosts the merchant's e-commerce website and provides various customer interaction functional capabilities that may be used. A web browser, executing upon the consumer's device, provides a display of the information being presented by the merchant's e-commerce website and enables the consumer, through various input means, to interact with website information, such as allowing the consumer to “shop online”.

During an online shopping session on the merchant's website, a customer can be enabled to add or select one or more products or other merchandise items. On e-commerce sites it is common that such a customer selection results in the addition of the selected product(s) to a shopping cart. Typically, a shopping cart is webpage of the merchant's website that provides the interface between the website and its back-end capabilities and allows consumers to select one or more product(s)/merchandise items; review selection(s) made; modify, add or remove a selection(s); and ultimately purchase desired product(s) and items. A “checkout” button (not shown) can be presented by the shopping cart and displayed to the consumer over their consumer device. Upon selection/clicking of this button the website initiates performance of the merchant's checkout process which may direct the customer to a checkout page or form. The checkout page, or at least a part of the checkout page, may request or require the customer to enter various information, which may or may not be considered sensitive information. For instance, the customer can or may not be required to enter their shipping address and select a preferred shipping method, and can or may not be requested to respond to a customer satisfaction survey or enter customer loyalty/reward program information. Upon capture of information that the merchant's checkout process determines necessary or required, the process may present the customer with a billing information screen. As described above, the billing information screen can be understood as the merchant's checkout form integrated with the SS interface, otherwise referred to herein as the SSCF. As described for the current invention the SS interface providing a communicative link between the merchant server 615 and a SS server 620.

The merchant's billing information screen can be provided in various manners by the website. The billing information screen may be displayed or perceived as an integrated part of the checkout form, a separate and distinct webpage from that of the checkout form or as a window or other subordinate display feature within the overall display framework of the checkout page. The billing information screen can display a customer perceived view containing one or more various data input fields, such as the billing name, address and credit or debit card fields (card number, expiration date and CSC or CVV) along with a “confirm” or “submit” button (not shown). Enabled by an implementation of the SS software of the current invention upon the merchant's server (or as hosted by an SS server), JavaScript can be injected into this view that will override the checkout form submission event so that said JavaScript controls the checkout form post to a payment processing network. As shown in the exemplary embodiment of FIG. 1, the customer can be presented with a display of the SSCF (105). The display being presented to the customer over their computing device 605. It is understood that the current contemplated transaction is enabling an online payment transaction where the input of customer payment information (credit or debit card fields) does not require the capture of payment card information from a swiping (reading of the magstrip) of a customer's payment card and therefore can be understood as a ‘card not present’ electronic payment transaction.

In order for the merchant server to post a checkout form a customer may be required to enter certain necessary data into one or more of the data input fields. In preferred embodiments, the customer is required to input data for the credit or debit card fields (card number, expiration date and CSC or CVV) and that input data is captured by the SS interface (110). Upon entry of necessary information into the input fields the customer can be enabled to click a confirm button (not shown). It is contemplated that prior to the entry of necessary information the customer may not be enabled to click the confirm button. Upon selection of the confirm button the data in the credit or debit card fields is accumulated and, along with the merchant's Public API key, is collected and securely transmitted (115) to the SS server 620. This transmission of data is protected using communication security protocols, such as HTML/TLSv1.

Upon receipt of the information transmitted from the SS interface, the SS server 620 uses that information in the execution of a tokenization process that results in the generation of a SUPT (120) for the requested payment transaction. The SS server 620 then transmits (125) the SUPT, via the SS interface, to the SSCF (merchant's server). The merchant server 615 eliminates the credit or debit card fields from the SSCF and inserts the SUPT (130) in order to generate a tokenized checkout form. With the tokenized checkout form generated the merchant server 615 can then submit or post (135) the form to the payment processing network.

In addition, and for certain preferred embodiments, the SS server 620 is a server of the payment processing network. In such embodiments, the merchant's server 615, being enabled to communicate with the SS server 620, can use the SUPT, along with the merchant's Secret API key and the billing address to submit a tokenized CreditSale or Debit sale to the SS server 620. The SS server 620 can determine whether or not to authorize the transaction and transmit either an authorization or an error to the merchant server 615. Where the transaction is authorized, the SS server 620 can communicate with other servers that are networked within the payment processing network for completion (e.g., clearance and settlement) of the payment transaction. The merchant server 615, via the e-commerce website, presents a response to the customer with the appropriate error or success screen (webpage).

### Example: 2

### JavaScript and IFrame—Combined Implementation

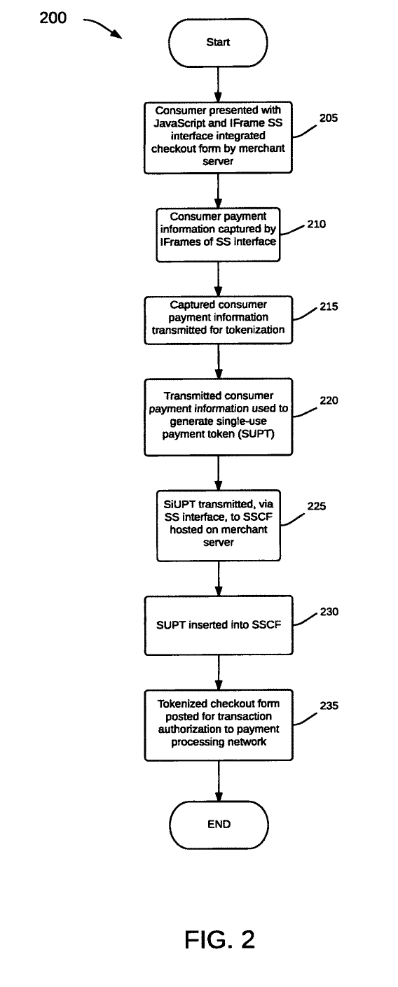

In the following example, and as illustrated in the method 200 of FIG. 2 capable of being implemented over an exemplary SS system such as system 700 of FIG. 7, the SS software is providing a JavaScript and iFrame implementation for the SS interface, wherein the SS interface is integrated in a checkout page provided by a merchant's website and enabling the tokenization capabilities provided by the current invention for a payment card not present transaction.

The e-commerce shopping experience and features described above for the JavaScript only example of the current invention can be understood as similar except for the differences for the JavaScript and iFrame example that are described below. Therefore, this example can begin with a customer, via their web-enabled consumer device 705 connected to a merchant server 715 over the Internet 710, adding a product to their shopping cart and clicking on “checkout” (not shown). While the exemplary illustration of FIG. 7 provides a device 705 in a generic computing device configuration, it is understood and described herein that the consumer device can be any web-enabled device, such as a mobile phone or smartphone. Therefore, FIG. 7 should not be understood as restrictive of the exemplary consumer computing device employed for the current invention. Initiation of the merchant's checkout process via the website can enable the customer to enter their shipping address, select a preferred shipping method and proceed to a billing information screen.

The billing information webpage, hosted by the merchant server 715, can serve up a view that can contain the billing name, address, and an IFrame 740 (otherwise referred to as the SS interface that is hosted on the SS server 720) with credit or debit card fields (card number, expiration day, expiration year and CVV) along with a “confirm” button. It is contemplated that the “confirm” button (not shown) of the current embodiment be hosted by the SS server 720 as part of the IFrame 740. Alternatively, the “confirm” button may be hosted by the merchant server as part of the billing information webpage or another webpage.

In preferred embodiments, the customer is required to input data for the credit or debit card fields (card number, expiration date and CSC or CVV) and that input data is captured by the IFrame (210). Upon entry of necessary information into the input fields the customer can be enabled to click the confirm button. It is contemplated that prior to the entry of necessary information the customer may not be enabled to click the confirm button. Upon selection of the confirm button the data in the credit or debit card fields is accumulated and, along with the merchant's Public API key, is collected and securely transmitted (215) to the SS server 720. This transmission of data is protected using communication security protocols, such as HTML/TLSv1.

It is contemplated that for all embodiments of the current invention, the form submission event can be enabled to occur either as the result of a manual act or automated process. For instance, a manual event may require the selection of the confirm button or the selection of an alternative option presented by the SS server or the merchant server. An automated event may require the completion of data entry into one or more input fields as has been described above herein.

Regardless, JavaScript is injected into the view of the billing information screen, such that the JavaScript enables an override of a form submission event so that said JavaScript controls the form post. Thus, upon selection or clicking on of the “confirm” button, a message is sent to the IFrame 740 (SS interface) to capture the credit or debit card fields and the merchant's Public API key and transmit such information to the SS server 720. Upon receipt of the information transmitted from the IFrame (SS interface), the SS server 720 uses that information in the execution of a tokenization process that results in the generation of a SUPT (220) for the requested payment transaction. The SS server 720 then transmits (225) the SUPT, via the IFrame SS interface, to the SSCF (merchant's server). The merchant server 715 eliminates the credit or debit card fields from the SSCF and inserts or adds the SUPT (230) in order to generate a tokenized checkout form. With the tokenized checkout form generated the merchant server 715 can then submit or post (235) the form to the payment processing network. Similar to that described above, it is contemplated that for certain preferred embodiments employing the SS interface as currently described, the SS server 720 is the gateway server of the payment processing network.

The SS server 720 can determine whether or not to authorize the transaction and transmit either an authorization or an error to the merchant server. Where the transaction is authorized, the SS server 720 can communicate with other servers that are networked within the payment processing network for completion (e.g., clearance and settlement) of the payment transaction. The merchant, via the e-commerce website, will respond to the customer with the appropriate error or success screen (webpage).

### Example: 3

### Encrypted and Non-Encrypted Track Tokenization

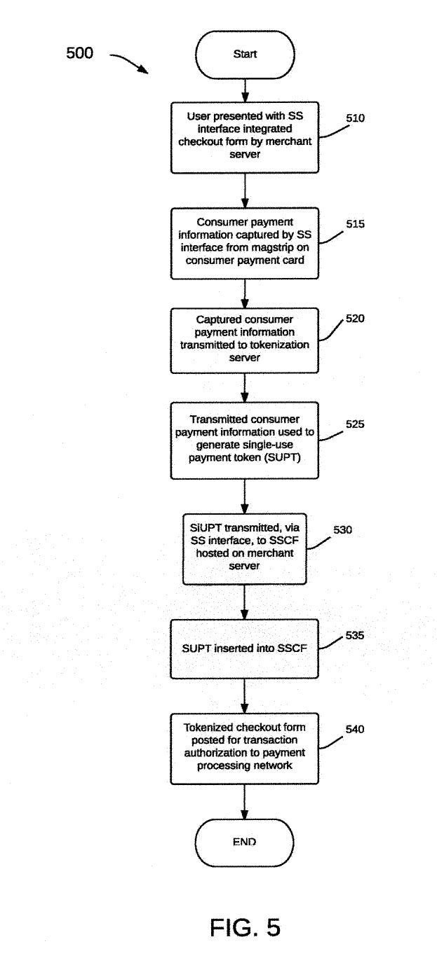

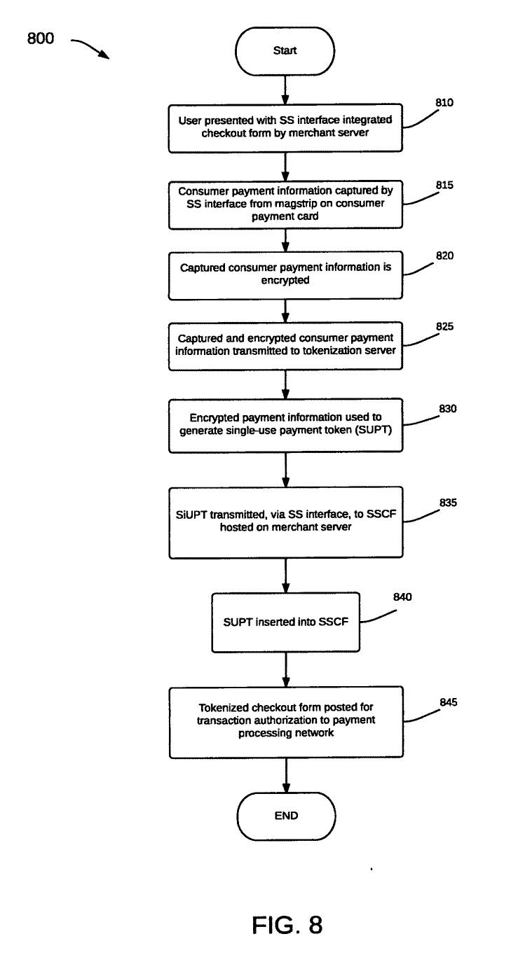

In the following example, and as further exemplified by the method 500, as shown in FIG. 5, and method 800, as shown in FIG. 8, the SS software is capable of providing an encrypted and non-encrypted track JavaScript implementation of the SS interface, wherein the SS interface is integrated in a checkout page provided by a merchant's website, displayed to a consumer (see 510 and 810) and enabling the tokenization capabilities provided by the current invention for a payment card present transaction.

It shall be understood that the contemplated transaction performance being described is enabling an online payment transaction where the input of customer payment information (credit or debit card fields) does require the presence of a customers payment (credit or debit) card and therefore is a ‘card present’ electronic payment transaction. The payment information collected from the payment card is understood to come from an encoding of payment information established on the payment card. This is commonly accomplished via a magnetic stripe (magstrip) that includes information encoded therein and may typically be referred to as track 1 and track 2 information. Regardless of the encoding configuration established by a payment card for the containment and transmission of payment information, the ‘swipe’ or reading of the magstrip allows for the capture of the payment information thereupon.

A merchant's e-commerce website can allow for entry of information from more than one networked computing device and that computing device does not necessarily need to be associated with a customer of the merchant. For instance, a staff member for a merchant may access the merchant website via a desktop computing device networked with the merchant's web-based system. During the performance of an electronic payment transaction the user may be directed to and presented with a checkout page or form (see 510 and 810).

Similar to that described above, the checkout form, or at least a part of the checkout form, may request or require the user to enter various information, which may or may not be considered sensitive and/or payment information. The capture of sensitive consumer payment information can be enabled via an SS interface which is integrated into the checkout form, which can be also referenced as the billing information screen or SSCF.

It is contemplated that the data capture functions enabled by the SS software for a transaction may be accomplished in coordination with the merchant's website and employ one or multiple web-pages, web-pages employing one or multiple windows and such other parent-child configurations as may be well-suited for the purpose. Therefore, a displayed SSCF can include the data capture fields allowing for the capture of all necessary consumer information to perform a transaction or may include a designated set of data capture fields that is designed to capture less than all necessary consumer information.

By way of example, upon capture of information that the merchant's checkout process determines required, but non-inclusive of other necessary information, the process may present the customer with a billing information screen. The billing information screen can display a view containing one or more various data input fields, such as the billing name, billing address, transaction (dollar) amount, and/or a “confirm” or “submit” button (not shown). It is further contemplated that the billing information screen may enable the user to select and input a customer's name into a data capture field on the screen. For instance, the customers name may be selected from a drop down menu presented over the merchant's web-based system and input that name into the checkout form. Additionally, a staff member or other user via the billing information screen can be enabled to input a dollar amount for the transaction to be performed. Selection of the customer name, entry of the dollar amount and any various other user interactions and/or data input that may be enabled for the billing information screen or other web-pages can be accomplished by any user, and employ and use any known interaction and/or input techniques. The capture of the above identified information can occur via a billing screen or other web-page that may or may not be embedded with an SS interface, such as the JavaScript and/or IFrame deployed SS interface. It is also contemplated for any embodiment of the current invention that an SS interface can be injected into any web-page, such as a billing screen webpage, presented during a checkout process.

The SS interface overrides the form submission event so that it controls the form post. For the current example, when the staff member clicks confirm, prior to a transaction authorization request being posted to a payment processing network, a prompt for the entry of payment card (credit or debit card) information is presented. Entry and capture of payment card information (see 515 and 815) by the staff member can be enabled by the swipe of the payment card using any known card reader device, point of sale (POS) device or other credit (or debit) card reading capable device that is in communication with and networked to the SS system. The card reading device must capture all necessary information contained or encoded on the magnetic stripe (magstrip) on the payment card, which can include the credit or debit card fields, such as payment card number, expiration day, expiration year and the CSC or CVV. It is contemplated that the card reader device can capture such other information as may be encoded on a magstrip and use such information in a transaction performance.

In the method 500, the consumer payment card information captured by the swipe of a payment card is used for generating a tokenization request transmittal via a similar process as has been previously described for tokenization request. In this process, the merchant's public API key is collected along with the accumulated payment information and transmitted (520) as at least part or all of the tokenization request, to the SS server. The transmission can be protected using various protocols, as has been described, and the SS server is enabled with decryption capabilities that allow it to decrypt the transmission protocols.

For exemplary method 800, shown at 820, indicates that in additional exemplary embodiments of the current invention that a networked card reading device and capability, whether enabled independently or in conjunction with another networked computing device, can provide data encryption, via a card reader device implemented with data encryption technology. A card reader device may be implemented with such data encryption technology as is known in the field, for instance, such as that described in U.S. patent application Ser. No. 12/816,356, entitled: Tamper-Resistant Secure Methods, Systems and Apparatuses for Credit and Debit Transactions, which is incorporated by reference herein. Such an encryption capable card reading device may be variously located and establish one or more encryption tracks or data types that represent the payment (credit or debit) card fields described above and/or such other information as may be necessary. It is also contemplated that the current invention only apply encryption to certain, specific data captured for a payment transaction. Thus, data capture can include encrypted and noon-encrypted data capture enabled by a card reader device employed for the current invention.

In still further embodiments, data encryption can be employed where data capture is not occurring by the use of a card reader device. Therefore, it is contemplated that various encryption protocols may be employed in conjunction or coordination with the data entry fields and/or input fields, as have been described previously herein. Thus, any online e-commerce environment networked within an SS system can employ the data encryption capabilities provided by the current invention in the performance of electronic payment transactions.

The consumer payment card information captured by the swipe of a payment card is encrypted (820) at the point of capture. This encrypted information can be referred to as an encrypted track or type of information. After the encrypted payment information is established the SS interface uses it for generating a tokenization request transmittal (825). Similar to the process described for tokenization request, the encrypted payment information is collected by the SS interface. The encrypted payment information can be an accumulation of encrypted payment information. The merchant's public API key is collected along with the accumulated encrypted information and transmitted, as the tokenization request, to the SS server. The transmission can be protected using various protocols, as has been described, and the SS server is enabled with decryption capabilities that allow it to decrypt the transmission protocols. The SS server, at step 830, can use the encrypted payment information (encrypted track) to generate a single-use payment token (SUPT). The SUPT can then be transmitted from the SS server to the merchant server via the SS interface as previously identified.

In both methods 500 and 800, as shown at 530 and 835, respectively, a message is sent from the SS server to the parent window (checkout form) of the merchant server. This message includes the SUPT, as generated from the processing performed in either method of consumer payment information, and triggers the merchant server to add a new SUPT field to the parent page (checkout form). The establishment of SUPT field can include the elimination of the payment card fields from the checkout form. The SUPT field is automatically populated with the SUPT transmitted from the SS server. It is contemplated that the SUPT field established in the checkout form, for any embodiments of the current invention, can be automatically populated by the transmission of the SUPT or can require a manual interaction with the checkout form to input the SUPT into the SUPT field. For instance, a consumer may be provided with a display of the checkout form that requires them to click a “confirm” button (not shown) to populate the SUPT field with the SUPT. This consumer confirmation capability may be enabled by the merchant server or the SS server and may allow for, but not necessarily require, transmission of the SUPT to/from the consumer device.

Upon population of the SUPT field by insertion of the SUPT, the checkout form can be and is submitted or posted (see 535 or 840) to the payment processing network gateway server. Similar to that described above, it is contemplated that for certain preferred embodiments employing the SS interface as currently described, the SS server(s) is the gateway server of the payment processing network. As such, for any embodiments of the current invention, the SS server can be understood as a server(s) enabled to handle and process encrypted and/or non-encrypted data and the encrypted and/or non-encrypted communications of such data.

The SS server(s) can determine whether or not to authorize the transaction and transmit either an authorization or an error to the merchant server. Where the transaction is authorized, the SS server can communicate with other servers that are networked within the payment processing network for completion (e.g., clearance and settlement) of the payment transaction. Where the transaction is not authorized the merchant server and/or SS server may perform such functions as are enabled by their transaction management capabilities and the merchant, via the e-commerce website, will respond to the customer with the appropriate error or success screen (webpage).

Computer system and/or website breaches or hacks in electronic transaction systems may result in the unauthorized access to sensitive information, such as a consumer's payment information or other sensitive information. The SS system promotes the immediate or timely notification of a potential breach to merchant's, or other e-commerce website owner(s)/hosting authority(ies), such that if a consumer's payment information (e.g., card numbers) is potentially or is being accessed by an unauthorized party the merchant may be notified within an effective time period. This notification may take many forms, for instance, the merchant may cease receiving merchandise orders from approved transactions because such transaction approvals require a posted transaction authorization request which requires an SUPT that cannot or may not be provided upon SS system breach. An effective time period is one that promotes breach notification reaching an interested party (e.g., merchant), networked servers or other networked computing devices in a timeframe that may enable the prevention of any loss of data and/or, to the fullest extent possible, the mitigation or minimizing of the loss of data resulting from a breach.

As described herein, transaction performance over an SS system can require the generation and transmission of an SUPT as a necessary component of any transaction authorization request and therefore any transaction approval from which the merchant receives valid merchandise orders. It is contemplated that various security protocols may be employed and enabled within an SS system that prohibits or prevents the tokenization capabilities of the current invention during transaction performance. Such tokenization restrictions, limitations, and prohibitions may effectively comprise and/or achieve a breach notification. For instance, if a breach occurs via an e-commerce website networked within an SS system, whether or not access to an SSCF web-page is achieved, the current invention may employ security protocols that prohibit or terminate performance of data input, data capture, data processing, data storage, tokenization request generation, transmission of a tokenization request and/or generation of a token. Failure to perform any of the above can result in a failure to post a complete checkout form.

For instance, IFrame enabled data capture and/or input fields employed by an SS interface to capture sensitive consumer payment information in an SSCF can also be enabled with tamper detection or various other security protocols. It is contemplated that a tamper detection capability can be provided or integrated with an SS interface using a tamper resistant security module (“TRSM”). As a component feature or part of server 400, FIG. 4 shows TRSM 459 as part of the applications suite 450 implemented upon the SS server 400. It is contemplated that a TRSM capability may be implemented in various networked locations, such as, merchant server or other networked server. The protocols established by the TRSM 459 can be enabled to detect various forms and instances of potential or occurring unauthorized activity (tampering) as are well known in the art. It is contemplated that any TRSM capability can be interfaced or integrated to the SS interface from any networked server or computing device within the SS system and can be employed with any SS system in the performance of ‘card not present’ or ‘card present’ transaction scenarios as described by this specification. Upon detection of tampering or suspected/attempted tampering the TRSM 459 may initiate a transmission of an alert, indication or other notification to the SS server of this unauthorized activity. Upon receipt of such a transmission from the SS interface, the SS server can initiate and/or effect a shut-down or termination of the SS interface and/or transmit a message, via the SS interface, to the merchant server providing notification of the unauthorized activity within an effective time period. The SS server, merchant server or other networked computing device or server can promote data security by suspending or terminating its or any transaction activity upon notification of unauthorized activity. It is also contemplated that upon suspension of transaction activity for a single, specific transaction the SS system may continue performing other transactions.

A TRSM or other security protocols employed by the current invention can effect a suspension or termination of the SS interface upon detection of tampering. Suspension or termination can be accomplished in various ways, such as from (1) a data capture override and/or (2) a communications override. It is contemplated that the functional capabilities provided by any TRSM or other security protocols can be employed individually or in any combination by the current invention. Where a data capture override is established it may prohibit or disable a data entry/input capability or data capture capability enabled for the SS interface where tampering is detected. For instance, where tampering is detected the communications bridge, enabling the data/information sent from a consumer device to reach the SS interface, can be temporarily or permanently disabled. This can minimize or prevent further exposure to breach by networked locations within the SS system.

It is also contemplated for the above scenario that the TRSM may enable a re-routing of communications to any local or networked location. This re-routing may allow the SS system to continue to perform other transactions while terminating the performance of the ‘at risk’ or breached transaction. These capabilities can promote minimizing or removing the risk of losing data from an instance of detected tampering. Further, it is contemplated that a data capture override can prohibit storage of captured data, either locally or in some networked location, or access to any data element or combination of elements that may have been captured by an SS interface. Access can occur at any data storage (temporary or permanent) location and may be typically made by a processor of another computing device for the continued performance of the transaction.

Where a communications override is established by a TRSM the communications link (protocol, capability or service) between the SS interface and SS server may be suspended or terminated upon the detection of any tampering (unauthorized) activity. This suspension or termination of communications can prohibit transmission of a tokenization request to the SS server. Where the SS server fails to receive a tokenization request, the SS server may be enabled to transmit an alert, indication or other notification to a merchant server (e-commerce website hosting authority and/or owner), or any other SS system networked server or computing device, of its failure to receive the tokenization request. This may provide a merchant with notification of the occurrence of a breach in an effective time period, can also prevent payment token (SUPT) generation and ultimately result in a failure to enable the merchant server to generate a complete checkout form and post a transaction authorization request.

Although the present invention has been described in detail, it should be understood that various changes, substitutions and alterations can be made hereto without departing from the sphere and scope of the invention as defined by the appended claims. Additionally, it is not intended that all embodiments of the invention exhibit one, some, or all of the described advantages. Furthermore, it is not intended that the listed advantages include an exhaustive list of the advantages that may be exhibited by the systems and methods described above.

The current invention has been described with reference to particular embodiments. However, it will be readily apparent to those skilled in the art that it is possible to modify the sequence of performance, order of execution, form, usage and/or details of implementation that embody the current invention in specific forms other than those of the embodiments described above without requiring the exercise of inventive faculty. The described embodiments are merely illustrative and should not be considered restrictive in any way. The scope of the invention is given by the appended claims, rather than the preceding description, and all variations and equivalents, which fall within the range of the claims are intended to be embraced therein.

To aid the Patent Office, and any readers of any patent issued on this application in interpreting the claims appended hereto, applicants wish to note that they do not intend any of the appended claims to invoke Section 6 of 35 U.S.C. §112 as it exists on the date of filing hereof unless “means for” or “step for” are used in the particular claim.

What is claimed is:

1. A method for performing an electronic payment transaction in an online commercial environment, comprising the steps of:
overriding the posting of a transaction authorization request by an override integrated within a checkout form that includes the transaction authorization request, wherein the checkout form allows for the capture of consumer payment data transmitted from a consumer device and the override enables transmission of the consumer payment data to a second server, wherein the first server presents the checkout form as part of an online commercial environment for processing an electronic payment transaction;
generating a single-use payment token based on the consumer payment data received by the second server, wherein the consumer payment data does not traverse, is not accessible to and is not stored by the first server; and transmitting the single-use payment token to the override;
posting a transaction authorization request to the second server by the first server, wherein the request comprises at least the checkout form including the single-use payment token received from the second server.

2. The method of claim 1, wherein the override does not require a re-direct of the consumer from the checkout form.

3. The method of claim 1, wherein the consumer payment data can be encrypted prior to transmission to the second server using various known techniques, methodologies and/or protocols.

4. The method of claim 1, wherein the consumer payment data can comprise at least one of a payment card (credit or debit) number, payment card expiration day, payment card expiration year, payment card security code (csc) number.

5. The method of claim 1, wherein the single-use payment token is unique to each data set of consumer payment data received.

6. The method of claim 1, wherein the override comprises at least one of a JavaScript, an iFrame and Javascript and an iFrame.

7. The method of claim 1, wherein the override can comprise at least one of an iFrame, two or more iFrames, three or more iFrames, and four or more iFrames that is/are integrated by the first server into the checkout form.

8. The method of claim 1, wherein at least one of an authentication protocol and security protocol is utilized for the transmission of the consumer payment data.

9. The method of claim 1, wherein the second server, via the override, communicates directly with a consumer via a web browser implemented on the consumer device.

10. The method of claim 1, wherein the consumer payment data is captured from a payment card by a card reading device networked to the first server.

11. The method of claim 10, wherein the captured consumer payment data is encrypted prior to its transmission to the second server.
